(19) United States
(12) Patent Application Publication
(10) Pub. No.: US 2009/0174555 A1
(43) Pub. Date: Jul. 9, 2009

(54) MESH-TYPE ANTI-THEFT DEVICE

(76) Inventor: Yung-San LIN, Ta Li City (TW)

Correspondence Address: EGBERT LAW OFFICES, 412 MAIN STREET, 7TH FLOOR, HOUSTON, TX, 77002, US

(21) Appl. No.: 11/969,910

(22) Filed: Jan. 6, 2008

(51) Int. Cl. G08B 13/14

(52) U.S. Cl. 340/568.1

(57) ABSTRACT

The present invention provides a mesh-type anti-theft device. The mesh-type anti-theft device includes a drive unit, drive axle, brake tooth, coupling rotary base and cutter assembly. As the drive unit is used to drive the brake tooth, the drive axle will generate rotation and axial displacement, enabling the rotation of coupling rotary base via a single-way bearing. The cutter assembly is driven to release the anti-theft mesh. With the centrifugal effect applied from the rotation of anti-theft mesh accommodating disc, the anti-theft mesh will be expanded in a centrifugal pattern.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an anti-theft device, and more particularly to an innovative anti-theft device with a mesh-type structure.

2. Description of Related Art Including Information Disclosed Under 37 CFR 1.97 and 37 CFR 1.98.

A common mesh-type anti-theft device is generally used to prevent theft and pilferage by release of anti-theft mesh with a mesh casting device. While the present invention is designed with a mesh casting device driven by high-pressure gas, some inventors have made attempts to develop different mesh-type anti-theft systems.

The following shortcomings are observed during actual applications. First, as anti-theft mesh is released by the mesh casting device driven by high-pressure gas, the anti-theft mesh will expand to fall down vertically; however, the fall-down speed of anti-theft mesh will increase under the thrust force applied by high-pressure gas, so anti-theft mesh may not be fully expanded, leading to escape by the stealers. Second, the anti-theft mesh is made of mesh wires with a gap. When the high-pressure gas is sprayed to anti-theft mesh, the gas will be partially discharged from the gap, so the thrust force will decline, resulting in a poor effect in release of anti-theft mesh.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

As the drive unit 20 is used to actuate the drive axle 40, the drive axle 40 drives the coupling rotary base 50 via a single-way bearing 52. When the rotation of drive axle 40 is stopped, the coupling rotary base 50 will rotate continuously under the inertial action, and then anti-theft mesh 80 is arranged through misalignment of cutter assembly 70. With the centrifugal effect applied from the rotation of anti-theft mesh accommodating disc 60, the anti-theft mesh 80 is expanded in a centrifugal pattern. Meanwhile, anti-theft mesh 80 is cast away from the anti-theft mesh accommodating disc 60 due to the centrifugal force, so the shortcomings of typical anti-theft mesh 80 can be improved. With this unique invention, the anti-theft mesh 80 expands the range of capture.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the present invention.

FIG. 2 shows a partially enlarged perspective view of the present invention.

FIG. 3 shows an exploded sectional view of the present invention.

FIG. 4 shows a partial perspective view of a structure of the present invention.

FIG. 5 shows a partially exploded perspective view of the present invention.

FIG. 6 shows a partially assembled perspective view of the present invention.

FIG. 7 shows an assembled sectional view of the present invention.

FIG. 8 shows a sectional view of the operation of the present invention.

FIG. 9 shows a partial schematic view of the operation of the present invention.

FIG. 10 shows a perspective view of an embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

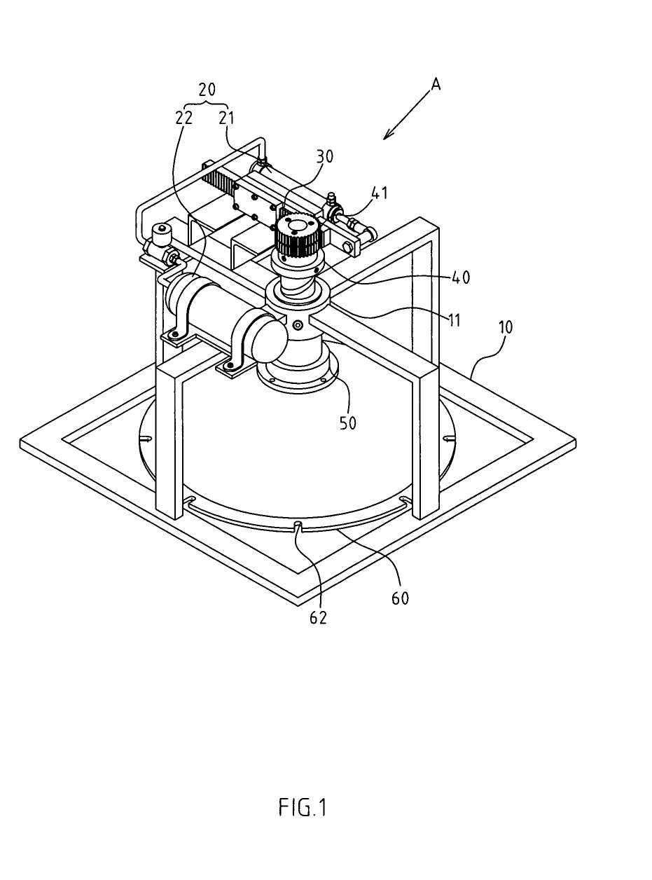

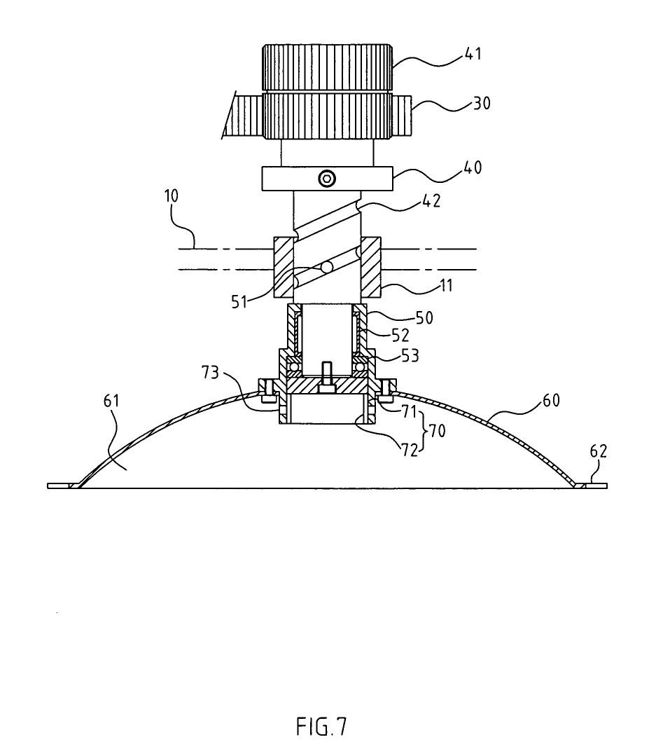

FIGS. 1-10 depict preferred embodiments of mesh-type anti-theft device of the present invention. The embodiments are only provided for explanatory purposes with respect to the patent claims.

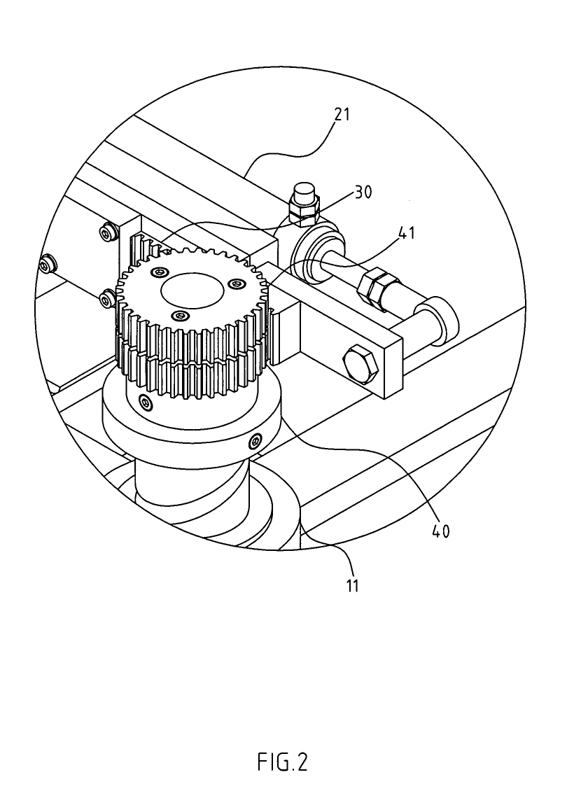

The mesh-type anti-theft device A comprises a localization frame 10, an axle seat 11, and a drive unit 20 assembled on a preset location of the localization frame 10. The drive unit comprises a telescopic drive cylinder 21 and a air storage unit 22. The air storage unit 22 is used to provide air pressure required for actuation of telescopic drive cylinder 21. A brake tooth 30 is transversely arranged, which may shift transversely to a predefined distance under the drive of telescopic drive cylinder 21 of the drive unit 20 (shown in FIGS. 1, 2).

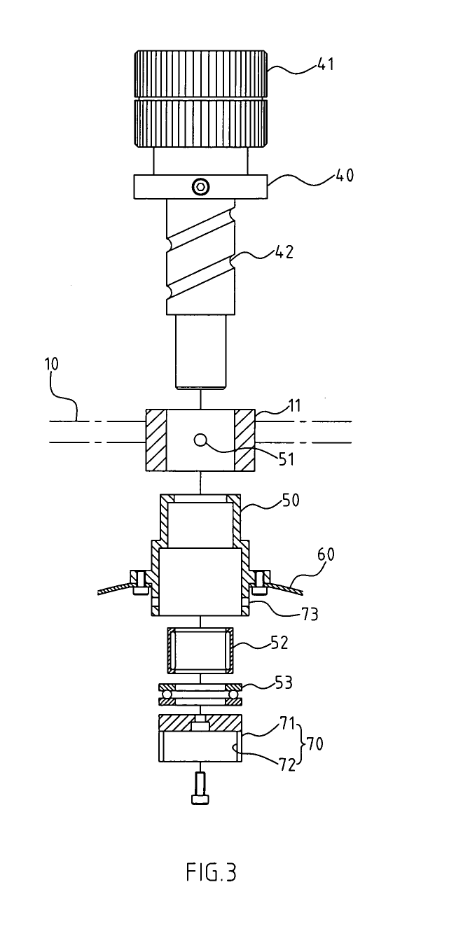

A drive axle 40 is adapted onto the axle seat 11 of the localization frame 10. A gear set 41 at top is engaged normally with the brake tooth 30, while a spiral slot 42 and drive portion 51 are coupled between the drive axle 40 and inner wall of axle seat 11, so that the drive axle 40 could generate rotation and axial displacement. The drive portion 51 is composed of at least one ball bearing assembled on the inner wall of the axle seat 11 (shown in FIG. 3).

A coupling rotary base 50 is assembled at the bottom of the drive axle 40. A single-way bearing 52 is mounted between the coupling rotary base 50 and drive axle 40, so that the drive axle 40 could drive uniaxially the coupling rotary base 50 for rotation.

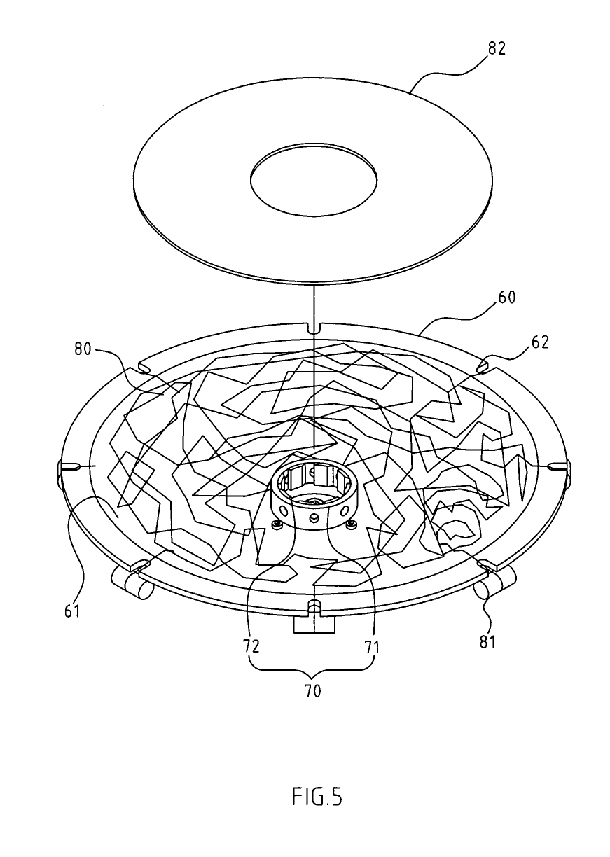

An anti-theft mesh accommodating disc 60 is linked to the bottom of the coupling rotary base 50 in a reverse disc shape, defining an accommodating portion 61 to place an anti-theft mesh 80. A plate-like limitation tray 82 is used to support and limit the anti-theft mesh 80. Some snapping portions 62 are arranged at intervals around the anti-theft mesh accommodating disc 60, so that various parts of anti-theft mesh 80 connected with a plumb body 81 are fastened into the snapping portion 62 (shown in FIG. 5).

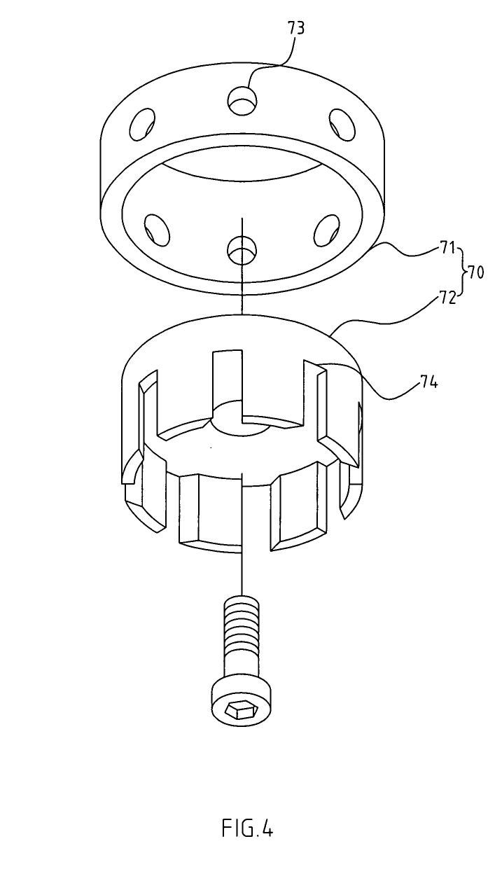

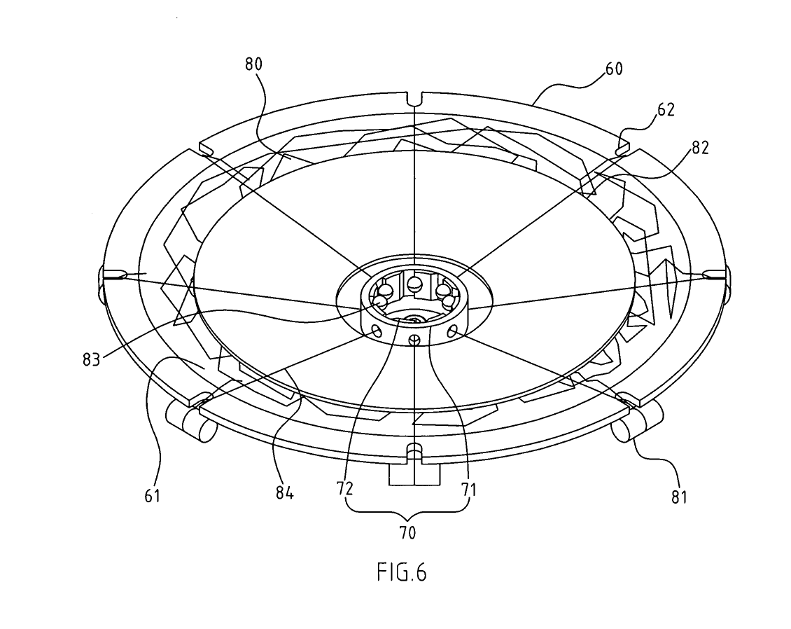

A cutter assembly 70 has an external body 71 and a cutter seat 72. The external body 71 is mounted onto the coupling rotary base 50, and the cutter seat 72 is mounted on the bottom of the drive axle 40. Moreover, mesh wire threading portions 73, 74 are arranged correspondingly between the external body 71 and cutter seat 72. The external body 71 and cutter seat 72 are of circular shapes. The mesh wire threading portion 73 of the external body 71 is of through-hole, and the mesh wire threading portion 74 of the cutter seat 72 is of split groove (shown in FIG. 4). One end of rope 84 is linked to the plumb body 81 of the snapping portion 62, and the other end is linked to the fixtures 83 by penetrating the mesh wire threading portions 73, 74 corresponding to the cutter assembly 70 for positioning purpose (shown in FIG. 6). An anti-thrust bearing 53 is located between the cutter seat 72 and coupling rotary base 50, so an acting force is formed to prevent an inertial and continuous rotation between the cutter seat 72 and external body 71.

Based upon above-specified structures, the present invention is operated as follows:

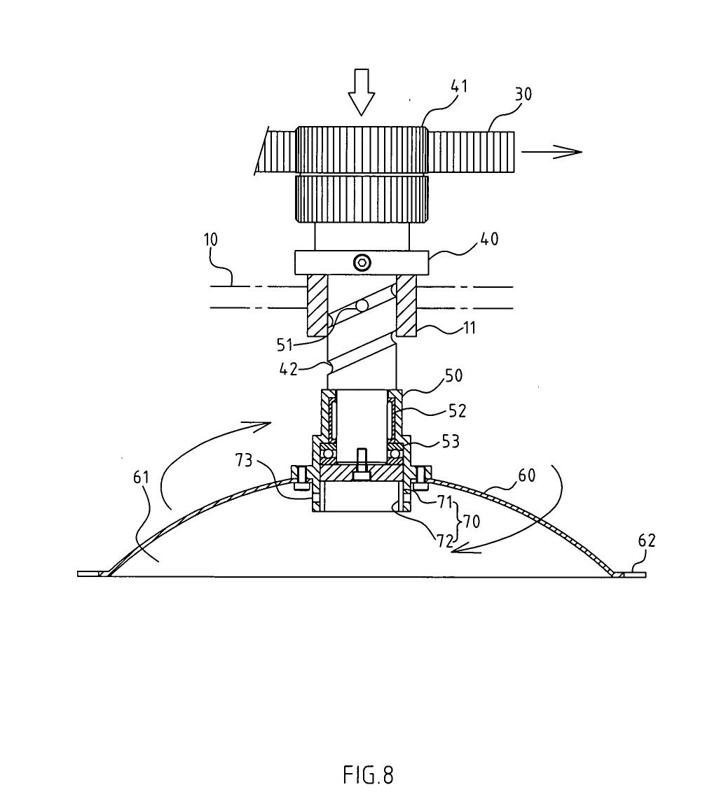

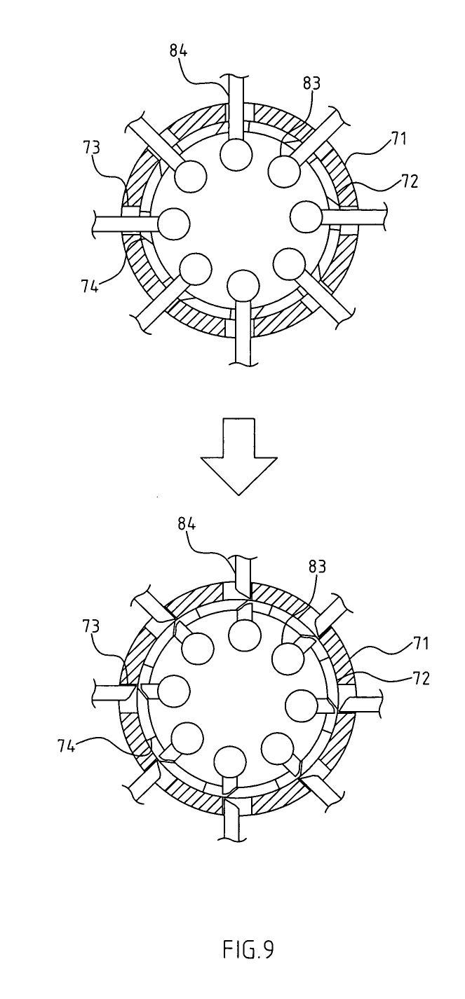

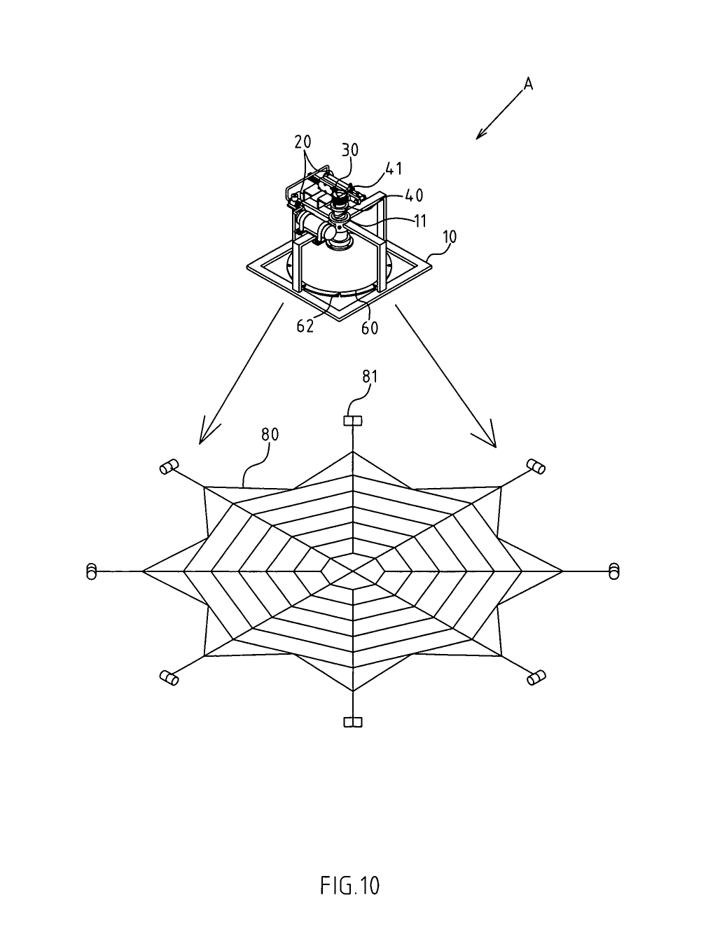

Referring to FIG. 8, an inductive switch is positioned at a preset location under the mesh-type anti-theft device A. Once this switch is touched, the mesh-type anti-theft device A will be actuated, or a starting switch is manually set to control the mesh-type anti-theft device A. In such a case, the drive unit 20 will drive the brake tooth 30 for transverse shift, enabling the drive axle 40 to drive the gear set 41 for rotation, and allowing axial shift via the coupling of spiral slot 42 and drive portion 51. A single-way bearing 52 is used to drive uniaxially the coupling rotary base 50, so that the cutter seat 72 connected with the drive axle 40 could stop after one-circle rotation. The coupling rotary base 50 will yield inertial and continuous rotation under the action of drive axle 40, thus driving the rotation of the external body 71. In such case, one end of the rope 84 located at the mesh wire threading portion 73, 74 is cut due to misalignment of the external body 71 and cutter seat 72 (shown in FIG. 9), so the plate-like limitation tray 82 for supporting anti-theft mesh 80 will lose the limitation, permitting fall-down of anti-theft mesh 80. With the centrifugal effect applied from the rotation of anti-theft mesh accommodating disc 60, the anti-theft mesh 80 is expanded in a centrifugal pattern, so that the expansion of anti-theft mesh 80 could be maximized (shown in FIG. 10).

1. A mesh-type anti-theft device, comprising:
a localization frame with an axle seat;
a drive unit, assembled on a preset location of said localization frame;
a brake tooth, transversely arranged, being transversely shifted to a predefined distance by said drive unit;
a drive axle, adapted onto said axle seat of said localization frame, said drive axle have a top with a gear set, said gear set being engaged normally with said brake tooth, said drive axle and said axle seat having a spiral slot and drive portion coupled therebetween, said drive axle generating rotational and axial displacement;
a coupling rotary base, assembled at a bottom of said drive axle;
a single-way bearing being mounted between said coupling rotary base and said drive axle, said drive axle uniaxially driving said coupling rotary base for rotation;
an anti-theft mesh accommodating disc, being linked to a bottom of said coupling rotary base in a reverse disc shape, defining an accommodating portion;
snapping portions arranged at intervals around said anti-theft mesh accommodating disc;
a cutter assembly, with an external body and a cutter seat, said external body being mounted onto said coupling rotary base, said cutter seat being mounted on a bottom of said drive axle, said cutter assembly having mesh wire threading portions arranged correspondingly between said external body and said cutter seat.

2. The device defined in claim 1, wherein said drive unit comprises:
a telescopic drive cylinder and an air storage unit, said air storage unit providing air pressure required for actuation of said telescopic drive cylinder.

3. The device defined in claim 1, wherein said drive portion is comprised of a ball bearing assembled on an inner wall of said axle seat.

4. The device defined in claim 1, wherein said external body and said cutter seat are of circular shape, said mesh wire threading portion of said external body being a through-hole and a split groove.

5. The device defined in claim 1, further comprising:
an anti-thrust bearing is located between said cutter seat and said coupling rotary base.

6. The device defined in claim 1, further comprising:
anti-theft mesh, having parts connected to a plumb body through a rope and being fastened into said snapping portion of said anti-theft mesh accommodating disc, said anti-theft mesh accommodating disc being provided with an accommodating portion to house said anti-theft mesh.

7. The device defined in claim 6, further comprising:
a plate-like limitation tray arranged at a bottom of said accommodating portion of said anti-theft mesh accommodating disc.
